(19) United States
(12) Patent Application Publication
(10) Pub. No.: US 2025/0360495 A1
(43) Pub. Date: Nov. 27, 2025

(54) PROCESS FOR PREPARING DOUBLE METAL CYANIDE CATALYSTS

(71) Applicant: Covestro Deutschland AG, Leverkusen (DE)

(72) Inventors: Joerg Hofmann, Krefeld (DE); Maria Gleixner, Kempen (DE); Thomas Asma, Tönisvorst (DE); Philipp Sander, Grevenbroich (DE)

(21) Appl. No.: 18/874,266

(22) PCT Filed: Jun. 29, 2023
(86) PCT No.: PCT/EP2023/067804

§ 371 Date: Dec. 12, 2024

(30) Foreign Application Priority Data
Jul. 4, 2022 (EP) 22182777.7

(51) Int. Cl. B01J 27/26; B01J 31/06; B01J 37/04; C08G 65/26

(52) U.S. Cl. CPC B01J 27/26; B01J 31/06; B01J 37/04; C08G 65/2663; B01J 2231/4288

(57) ABSTRACT

The present invention relates to an improved process for preparing double metal cyanide (DMC) catalysts for the preparation of polyoxyalkylene polyols, preferably polyether polyols and/or polyether carbonate polyols. The invention further provides DMC catalysts which are obtainable by this process and for the use of the catalysts according to the invention for preparing polyoxyalkylene polyols.

The present invention relates to an improved process for preparing double metal cyanide (DMC) catalysts for the preparation of polyoxyalkylene polyols, preferably polyether polyols and/or polyether carbonate polyols. The invention further provides DMC catalysts obtainable by this process and for the use of the catalysts according to the invention for preparing polyoxyalkylene polyols.

DMC catalysts are known in principle from the prior art (see, for example, U.S. Pat. Nos. 3,404,109, 3,829,505, 3,941,849, and 5,158,922). DMC catalysts, which are described, for example, in U.S. Pat. No. 5,470,813, EP-A 700 949, EP-A 743 093, EP-A 761 708, WO 97/40086, WO 98/16310, WO 00/47649 and WO 2021/165283 A1 have a very high activity in the homopolymerization of epoxides and enable the preparation of polyether polyols at very low catalyst concentrations (25 ppm or less), such that removal of the catalyst from the finished product may no longer be required. A typical example is that of the highly active DMC catalysts which are described in EP-A 700 949 and contain not only a double metal cyanide compound (e.g. zinc hexacyanocobaltate(III)) and an organic complex ligand (e.g. tert-butanol) but also a polyether having a number-average molecular weight greater than 500 g/mol.

WO 01/39883 A1 discloses a process for preparing double metal cyanide (DMC) catalysts for the preparation of polyether polyols by polyaddition of alkylene oxides onto starter compounds having active hydrogen atoms, the DMC catalyst dispersion being prepared in this process using a mixing nozzle, preferably a jet disperser. The DMC catalysts thus prepared have increased activity in the preparation of polyether polyols, reduced particle size and a narrower particle size distribution.

WO 01/80994 A1 likewise discloses a process for preparing double metal cyanide (DMC) catalysts, in which aqueous solutions of a metal salt and of a metal cyanide salt are first reacted in the presence of an organic complex ligand and optionally one or more further complex-forming components to form a DMC catalyst dispersion, this dispersion is then filtered, the filtercake is subsequently washed with one or more aqueous or nonaqueous solutions of the organic complex ligand and optionally one or more further complex-forming components by filtercake washing, and the washed filtercake is finally dried after an optional pressing out or mechanical moisture removal. The process disclosed shortens the time for catalyst preparation, the resulting catalysts possessing comparable activities in the preparation of polyether polyols in comparison to reference catalysts.

EP 700 949 A2 describes a DMC catalyst, containing DMC compound, an organic complex ligand and 5%-80% by weight of a polyether having a number-average molecular weight of >500 g/mol, the preparation of the DMC catalyst dispersion being effected at room temperature. The catalysts used generally possess an activity in the preparation of polyether polyols.

WO 2021/148272 A1 discloses a process for preparing a double metal cyanide catalyst (DMC), wherein the resulting DMC catalysts exhibit an elevated catalytic activity in the preparation of polyoxyalkylene polyols, for example in the catalyst test according to the “8K diol stressed test”. This comprises reaction of an aqueous solution of a cyanide-free metal salt, an aqueous solution of a metal cyanide salt, an organic complex ligand and propylene glycol as a complex-forming component to form a dispersion, wherein the reaction is carried out using a mixing nozzle and wherein the process temperature of the dispersion during the reaction is between 26° C. and 49° C.

It is an object of the present invention to provide an improved process for preparing double metal cyanide (DMC) catalysts having further increased catalytic activity in the preparation of polyoxyalkylene polyols, preferably polyether polyols and/or polyethercarbonate polyols, this improved activity resulting in a reduced product viscosity for example in catalyst testing in a semi-batch polyol preparation process according to the “8K diol stressed test” described for example in WO 98/16310 A1 but also in a continuous polyol preparation process. The objective was thus to provide catalytically more active DMC catalysts which result in polyoxyalkylene polyols, preferably polyether polyols and/or polyethercarbonate polyols, having a reduced viscosity, thus facilitating the further processability of the polyoxyalkylene polyols in the subsequent polyurethanization reaction. The increased catalyst activity moreover enables a reduction in the amount of catalyst used, which improves the economic viability of the process.

At the same time, the process for preparing the DMC catalyst dispersion should be carried out with a comparably simple apparatus setup, a low energy demand during shearing, good temperature control, and likewise good scalability compared to known industrial processes to enable simple implementation in existing DMC catalyst preparation processes, for example in loop reactors.

It has now been found that, surprisingly, the aforementioned object is achieved by a process for preparing a double metal cyanide (DMC) catalyst comprising
i) reacting an aqueous solution of a cyanide-free metal salt, an aqueous solution of a metal cyanide salt, an organic complex ligand and a complex-forming component, characterized in that the complex-forming component contains one or more compounds (1) of formula (I):

R₁—O—(R₂—O)ₙ—H (I)
where
R₁ is a substituted or unsubstituted aryl group,
R₂ is an alkylene group, preferably an ethylene group or isopropylene group, particularly preferably ethylene group (Et), and
n≥1, preferably 5≤n<80, particularly preferably 7≤n≤70, very particularly preferably 8≤n≤60.

The invention will now be more particularly elucidated hereinbelow, wherein the embodiments according to the invention may be combined with one another provided the opposite is not apparent from the technical context.

### Complex-forming component

### Compound (1)

According to the invention the complex-forming component contains one or more compounds (1) of formula (I):

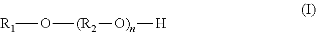

where
R₁ is a substituted or unsubstituted aryl group,
R₂ is an alkylene group, preferably an ethylene group or isopropylene group, particularly preferably ethylene group (Et), and
n≥1, preferably 5≤n≤80, particularly preferably 7≤n≤70, very particularly preferably 8≤n≤60.

In one embodiment of the process according to the invention, R₁ has a structure according to formula (II):

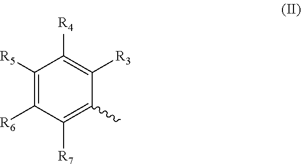

where
R₃, R₄, R₅, R₆, R₇ are independently of one another selected from the group consisting of hydrogen, linear or branched alkyl groups having 1 to 22 carbon atoms, cycloaliphatic groups containing 3 to 22 carbon atoms and substituted or unsubstituted aryl groups having 6 to 16 carbon atoms.

In a preferred embodiment of the process according to the invention, R₃, R₅, and R₇ are independently of one another selected from the group consisting of hydrogen, linear or branched alkyl groups having 1 to 22 carbon atoms, cycloaliphatic groups containing 3 to 22 carbon atoms and substituted or unsubstituted aryl groups having 6 to 16 carbon atoms and R₄ and R₆ are hydrogen.

In a particularly preferred embodiment of the process according to the invention, R₃, R₅ and R₇ are independently of one another selected from the group consisting of linear or branched alkyl groups having 1 to 10 carbon atoms and substituted or unsubstituted aryl groups having 6 to 12 carbon atoms and R₄ and R₆ are hydrogen.

In one embodiment of the process according to the invention, R₁ has a structure according to formula (III), (IV) or (V):

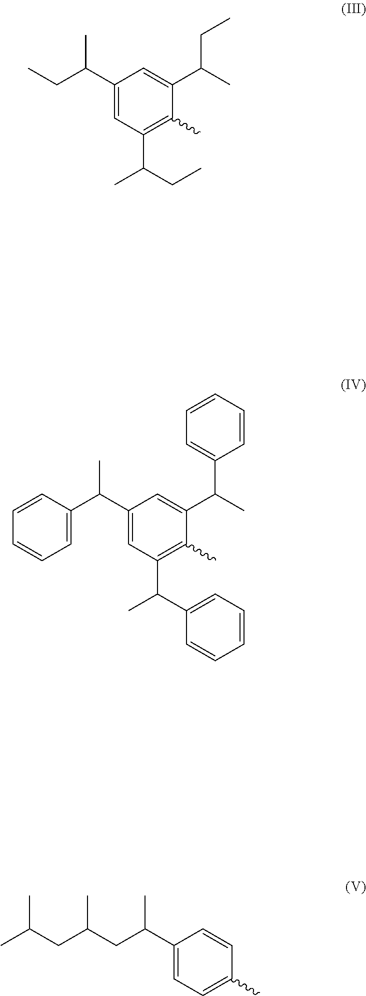

In a preferred embodiment of the process according to the invention, R₁ has a structure according to formula (III).

In one embodiment of the process according to the invention, the compound (1) has a structure according to formula (VI), (VII) and/or (VIII):

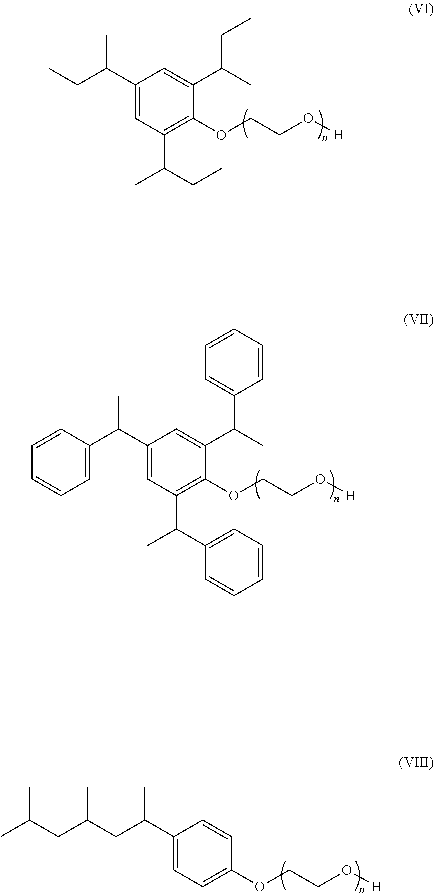

where n≥1, preferably 5≤n≤80, particularly preferably 7≤n≤70, most preferably 8≤n≤60.

In a preferred embodiment of the process according to the invention, the compound (1) has a structure according to formula (VI) where 5≤n≤80, preferably 7≤n≤70 and particularly preferably 8≤n≤60, wherein this compound (VI) is also referred to as tri-sec-butylphenol ethoxylate having 5 to 80, preferably 7 to 70 and particularly preferably 8 to 60 ethoxy units.

### Compound (2)

In one embodiment of the process according to the invention, the complex-forming component contains not only the compound (1) but also one or more compounds (2), wherein the compound (2) may be selected from the compound classes of polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkyl acrylates, polyalkyl methacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkyleneimines, maleic acid and maleic anhydride copolymers, hydroxyethylcellulose and polyacetals, or of the glycidyl ethers, glycosides, carboxylic esters of polyhydric alcohols, esters or amides, cyclodextrins or phosphorus compounds.

In the process according to the invention for preparing DMC catalysts it is preferable to employ polyether as compound (2).

In a preferred embodiment, the polyether has a number-average molecular weight of ≥500 g/mol, the number-average molecular weight being calculated from the determined OH number.

OH numbers are determined according to the method of DIN 53240.

Suitable polyethers include those which are prepared by means of the ring-opening polymerization of cyclic ethers, these cyclic ethers for example also comprising oxetane polymers and also tetrahydrofuran polymers. Any form of catalysis is possible for this purpose. The polyether has suitable end groups here, such as for example hydroxyl, amine, ester or ether end groups.

In a particularly preferred embodiment, the polyether has an average hydroxyl functionality of from 2 to 8 and a number-average molecular weight in the range from 500 g/mol to 10 000 g/mol, preferably of from 700 g/mol to 5000 g/mol, the number-average molecular weight being calculated from the determined OH number.

In a particularly preferred embodiment, the polyethers are polyether polyols, the polyether polyols being obtained by reaction of alkylene oxides and H-functional starter compounds in the presence of acidic, basic and/or organometallic catalysts. These organometallic catalysts are for example double metal cyanide (DMC) catalysts.

Suitable polyether polyols are poly(oxypropylene) polyols, poly(oxypropyleneoxyethylene) polyols, polytetramethylene ether glycols and block copolymers containing poly(oxy)ethylene, poly(oxy)propylene and/or poly(oxy)butylene blocks, such as for example poly(oxy)ethylene-poly(oxy)propylene block copolymers having terminal poly(oxy)ethylene blocks.

In a preferred embodiment, the polyether polyol is a poly(oxypropylene) polyol having a number-average molecular weight of ≥500 g/mol, the number-average molecular weight being calculated from the determined OH number.

In a particularly preferred embodiment, the polyether polyol is a poly(oxypropylene) polyol, preferably a poly(oxypropylene) diol and/or a poly(oxypropylene) triol having a number-average molecular weight of 700 g/mol to 4000 g/mol, the number-average molecular weight being calculated from the determined OH number.

In an alternative embodiment, the polyethers have an average hydroxyl functionality of from 2 to 8 and a number-average molecular weight in the range from 150 g/mol to less than 500 g/mol, preferably of from 200 g/mol to 400 g/mol, the number-average molecular weight being calculated from the determined OH number.

In a preferred alternative embodiment, the alternative polyethers are polyether polyols, these alternative polyether polyols having an average hydroxyl functionality of from 2 to 8 and a number-average molecular weight in the range from 150 g/mol to less than 500 g/mol, preferably an average hydroxyl functionality of from 2 to 8 and a number-average molecular weight in the range from 200 g/mol to 400 g/mol, the number-average molecular weight being calculated from the determined OH number. These alternative polyether polyols are likewise obtained by reaction of alkylene oxides and H-functional starter compounds in the presence of acidic, basic and/or organometallic catalysts.

These organometallic catalysts are for example double metal cyanide (DMC) catalysts.

Suitable alternative polyether polyols are poly(oxypropylene) polyols, poly(oxypropyleneoxyethylene) polyols, polytetramethylene ether glycols and block copolymers containing poly(oxy)ethylene, poly(oxy) propylene and/or poly(oxy)butylene blocks, such as for example poly(oxy)ethylene-poly(oxy)propylene block copolymers having terminal poly(oxy)ethylene blocks. Tripropylene glycol, triethylene glycol, tetrapropylene glycol, tetraethylene glycol, dipropylene glycol monomethyl ether, tripropylene glycol monomethyl ether, and monoalkyl and dialkyl ethers of glycols and poly(alkylene glycol)s are furthermore also suitable.

In a particularly preferred alternative embodiment, the alternative polyether polyol is a polypropylene glycol and/or a polyethylene glycol having a number-average molecular weight in the range from 150 g/mol to less than 500 g/mol, the number-average molecular weight being calculated from the determined OH number.

In a preferred embodiment of the process according to the invention, the molar ratio of compound (1) to compound (2) is from 50:1 to 1:50, preferably 20:1 to 1:20.

In an alternative embodiment of the process according to the invention, the complex-forming component contains no additional compound (2) in addition to the compound (1).

### Cyanide-Free Metal Salt

Cyanide-free metal salts suitable for preparation of the double metal cyanide compounds preferably have the general formula (IX),

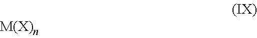

wherein
M is selected from the metal cations Zn²⁺, Fe²⁺, Ni²⁺, Mn²⁺, Co²⁺, Sr²⁺, Sn²⁺, Pb²⁺ and Cu²⁺; M is preferably Zn²⁺, Fe²⁺, Co²⁺ or Ni²⁺,
X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;
n is 1 when X=sulfate, carbonate or oxalate and
n is 2 when X=halide, hydroxide, cyanate, thiocyanate, isocyanate, isothiocyanate or nitrate,
or suitable cyanide-free metal salts have the general formula (X),

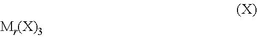

wherein
M is selected from the metal cations Fe³⁺, Al³⁺ and Cr³⁺,
X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;
r is 2 when X=sulfate, carbonate or oxalate and
r is 1 when X=halide, hydroxide, cyanate, thiocyanate, isocyanate, isothiocyanate, carboxylate or nitrate,
or suitable cyanide-free metal salts have the general formula (XI),

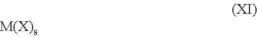

wherein
M is selected from the metal cations Mo⁴⁺, V⁴⁺ and W⁴⁺,
X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;
s is 2 when X=sulfate, carbonate or oxalate and
s is 4 when X=halide, hydroxide, cyanate, thiocyanate, isocyanate, isothiocyanate, carboxylate or nitrate,
or suitable cyanide-free metal salts have the general formula (XII),

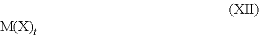

wherein
M is selected from the metal cations Mo⁶⁺ and W⁶⁺,
X are one or more (i.e. different) anions, preferably an anion selected from the group of halides (i.e. fluoride, chloride, bromide, iodide), hydroxide, sulfate, carbonate, cyanate, thiocyanate, isocyanate, isothiocyanate, carboxylate, oxalate and nitrate;
t is 3 when X=sulfate, carbonate or oxalate and
t is 6 when X=halide, hydroxide, cyanate, thiocyanate, isocyanate, isothiocyanate, carboxylate or nitrate.

In a preferred embodiment of the process according to the invention, the cyanide-free metal salt of the aqueous solution of a cyanide-free metal salt is one or more compounds selected from the group consisting of zinc chloride, zinc bromide, zinc iodide, zinc acetate, zinc acetylacetonate, zinc benzoate, zinc nitrate, iron(II) sulfate, iron(II) bromide, iron(II) chloride, cobalt(II) chloride, cobalt(II) thiocyanate, nickel(II) chloride and nickel(II) nitrate, particularly preferably zinc chloride.

### Metal Cyanide Salt

Metal cyanide salts suitable for preparing the double metal cyanide compounds preferably have the general formula (XIII)

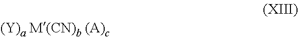

wherein
M′ is selected from one or more metal cations from the group consisting of Fe(II), Fe(III), Co(II), Co(III), Cr(II), Cr(III), Mn(II), Mn(III), Ir(III), Ni(II), Rh(III), Ru(II), V(IV) and V(V); M′ is preferably one or more metal cations from the group consisting of Co(II), Co(III), Fe(II), Fe(III), Cr(III), Ir(III) and Ni(II),
Y is selected from one or more metal cations from the group consisting of alkali metal (i.e. Li⁺, Na⁺, K⁺, Rb⁺, Cs⁺) and alkaline earth metal (i.e. Be²⁺, Ca²⁺, Mg²⁺, Sr²⁺, Ba²⁺),
A is selected from one or more anions from the group consisting of halides (i.e. fluoride, chloride, bromide, iodide), hydroxide, sulfate, carbonate, cyanate, thiocyanate, isocyanate, isothiocyanate, carboxylate, oxalate or nitrate and
a, b and c are integers, wherein the values for a, b and c are selected so as to ensure the electroneutrality of the metal cyanide salt; a is preferably 1, 2, 3 or 4; b is preferably 4, 5 or 6; c preferably has the value 0.

In a preferred embodiment of the process according to the invention, the metal cyanide salt of the aqueous solution of a metal cyanide salt is one or more compounds selected from the group consisting of potassium hexacyanocobaltate(III), potassium hexacyanoferrate(II), potassium hexacyanoferrate(III), calcium hexacyanocobaltate(III) and lithium hexacyanocobaltate(III), particularly preferably potassium hexacyanocobaltate(III).

Preferred double metal cyanide compounds present in the DMC catalysts according to the invention are compounds of the general formula (XIV)

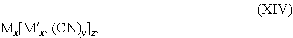

where M is as defined in formula (IX) to (XII) and
M′ is as defined in formula (XIII) and x, x′, y and z are integers and are selected so as to ensure the electronic neutrality of the double metal cyanide compound.

It is preferable when x=3, x′=1, y=6 and z=2, M is Zn(II), Fe(II), Co(II) or Ni(II) and M′ is Co(III), Fe(III), Cr(III) or Ir(III).

In a preferred embodiment of the process according to the invention, the double metal cyanide compound is one or more compounds selected from the group consisting of zinc hexacyanocobaltate(III), zinc hexacyanoiridate(III), zinc hexacyanoferrate(III) and cobalt(II) hexacyanocobaltate(III). Particular preference is given to using zinc hexacyanocobaltate(III).

### Organic Complex Ligand

The organic complex ligands added in the preparation of the DMC catalysts are disclosed, for example, in U.S. Pat. No. 5,158,922 (see especially column 6, lines 9 to 65), U.S. Pat. No. 3,404,109, 3,829,505, 3,941,849, EP-A 700 949, EP-A 761 708, JP 4 145 123, U.S. Pat. No. 5,470,813, EP-A 743 093, WO 99/46042 and WO-A 97/40086). The organic complex ligands used are, for example, water-soluble organic compounds containing heteroatoms such as oxygen, nitrogen, phosphorus or sulfur, which can form complexes with the double metal cyanide compound. Preferred organic complex ligands are alcohols, aldehydes, ketones, ethers, esters, amides, ureas, nitriles, sulfides and mixtures thereof. Particularly preferred organic complex ligands are aliphatic ethers (such as dimethoxyethane), water-soluble aliphatic alcohols (such as ethanol, isopropanol, n-butanol, isobutanol, sec-butanol, tert-butanol, 2-methyl-3-buten-2-ol and 2-methyl-3-butyn-2-ol), compounds containing both aliphatic or cycloaliphatic ether groups and aliphatic hydroxyl groups (for example ethylene glycol mono-tert-butyl ether, diethylene glycol mono-tert-butyl ether, tripropylene glycol monomethyl ether and 3-methyl-3-oxetanemethanol). The most preferred organic complex ligands are selected from one or more compounds from the group consisting of dimethoxyethane, tert-butanol, 2-methyl-3-buten-2-ol, 2-methyl-3-butyn-2-ol, ethylene glycol mono-tert-butyl ether and 3-methyl-3-oxetanemethanol.

In a preferred embodiment of the process according to the invention, the organic complex ligand is one or more compounds selected from the group consisting of dimethoxyethane, tert-butanol, 2-methyl-3-buten-2-ol, 2-methyl-3-butyn-2-ol, ethylene glycol mono-tert-butyl ether and 3-methyl-3-oxetanemethanol, particularly preferably tert-butanol.

### Mixing Nozzle

The DMC catalyst dispersion is preferably prepared using a mixing nozzle (for example a smooth jet nozzle, Levos nozzle, Bosch nozzle and the like), particularly preferably a jet disperser, such as is described in the patent application WO 01/39883 A1.

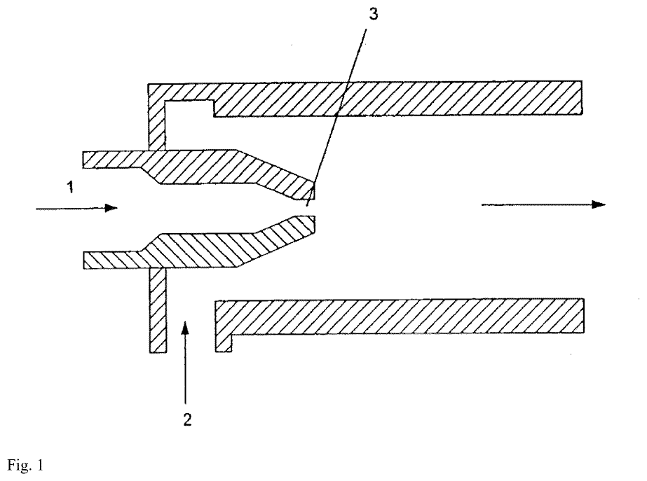

The basic structure and mode of operation of suitable mixing nozzles will be described hereinbelow. FIG. 1 shows the schematic structure of a simple smooth jet nozzle. The reactant stream 1 is first accelerated in the nozzle 3 and sprayed at a high flow speed into the slow-flowing reactant stream 2. In the process, reactant stream 2 is accelerated and reactant stream 1 is decelerated. Part of the kinetic energy of reactant jet 1 is converted into heat in this process and is thus no longer available for the mixing operation. The two reactant streams are subsequently mixed via the turbulent decay of the resulting jet into vortices of different sizes (vortex cascade). Compared to a stirred tank, concentration differences can be reduced much more rapidly in this way, as much greater and more homogeneous power densities can be achieved. The average power density P is calculated here by the following formula:

$$P = \frac{Δ p \cdot \dot{V}}{V}$$

where: Δp: pressure drop in the nozzle
\dot{V}: volume flow rate
V: volume of the nozzle bore

The use of such nozzles shall hereinbelow be referred to as method 1.

In a smooth jet nozzle, a first reactant stream is first accelerated in a nozzle and sprayed at a high flow speed into a slow-flowing second reactant stream. The two reactant streams are subsequently mixed via the turbulent decay of the resulting jet into vortices of different sizes (vortex cascade). Compared to a stirred tank, concentration differences can be reduced much more rapidly in this way, as much greater and more homogeneous power densities can be achieved.

### Jet disperser

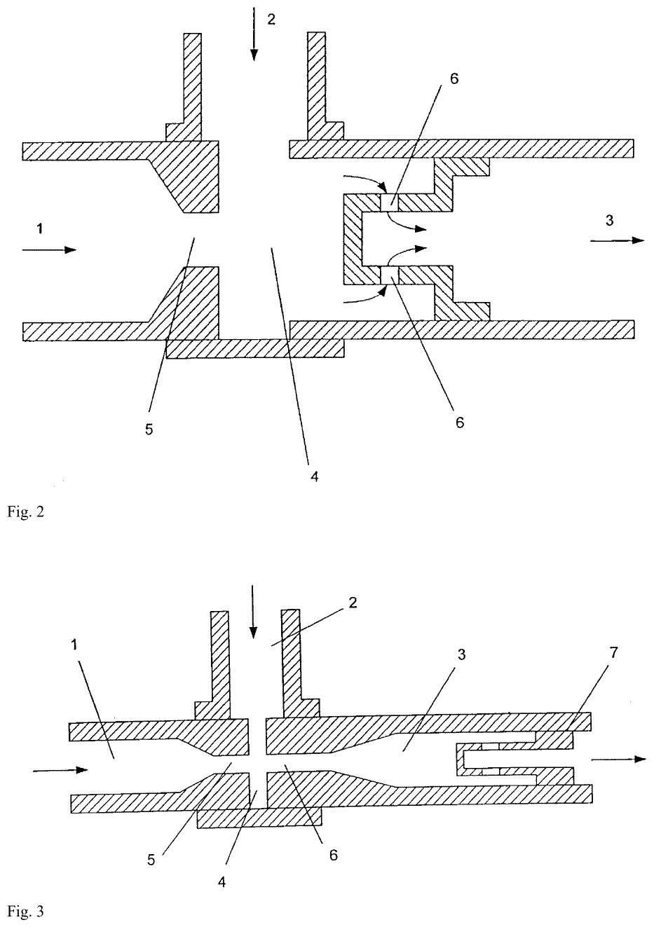

Particular preference is given to using a jet disperser as is illustrated in FIG. 2 or FIG. 3 for the process according to the invention. The jet disperser can be constructed (FIG. 2) such that two nozzles 5 and 6 are arranged in succession. The reactant stream 1 is first greatly accelerated in the nozzle 5 by the cross-sectional constriction. The accelerated jet in the process draws in the second component due to the high flow speed. The spacing of the nozzles is preferably selected so that only nucleation, but no crystal growth, occurs in the mixing chamber 4 on account of the short residence time. The decisive factor for the optimal design of the jet disperser is thus the nucleation rate of the solid. A residence time of 0.0001 s to 0.15 s, preferably 0.001 s to 0.1 s, is advantageously set. Crystal growth does not take place until in the outlet 3. The diameter of the nozzles 6 should preferably be selected so that the partially mixed reactant streams are accelerated further there. Due to the shear forces additionally arising as a result in the nozzles 6, compared to method 1, the state of homogeneous mixing is achieved in a shorter time because of a more rapid vortex decay. As a result, in contrast to method 1, it is possible even in the case of precipitation reactions with a very high nucleation rate to achieve the state of ideal mixing of the reactants, so that the setting of defined stoichiometric compositions during the precipitation reaction is possible. Nozzle diameters of from 5000 μm to 50 μm, preferably 2000 μm to 200 μm, have proven to be advantageous with pressure drops in the nozzle of 0.1 bar to 1000 bar or power densities in the range from 1*10⁷ W/m³ to 1*10¹³ W/m³. This mixing operation will be designated hereinbelow as method 2.

Depending on the desired particle size, a further n nozzles (with n=1-5) may be connected downstream so as to obtain a multistage jet disperser. FIG. 3 shows such a multistage jet disperser. Following the nozzle 6, the dispersion is once more guided through the nozzle 7. For the design of the nozzle diameter, the same applies as for nozzle 6.

The additional advantage of further dispersers compared to method 2 consists in that particles which have already formed can be mechanically comminuted by the large shear forces in the nozzles. In this way it is possible to produce particles having diameters of from 10 μm to 0.1 μm. Instead of a plurality of nozzles connected in series, comminution can also be achieved by circulating the dispersion. The use of such nozzles is hereinbelow referred to as method 3.

The energy dissipation in the nozzles and the enthalpy of crystallization can result in heating of the dispersion. Since the temperature can have a substantial influence on the crystal formation process, a heat transfer means may be installed downstream of the mixing element for the isothermal process regime.

A problem-free scale-up is for example possible by using a greater number of bores, connecting a plurality of mixing elements in parallel or enlarging the free nozzle area. However, the latter is not achieved by increasing the nozzle diameter, as this gives rise to the possibility of the occurrence of a core flow which results in a deterioration in the mixing result. For nozzles having large free nozzle areas, it is therefore preferable to use slits having a corresponding area.

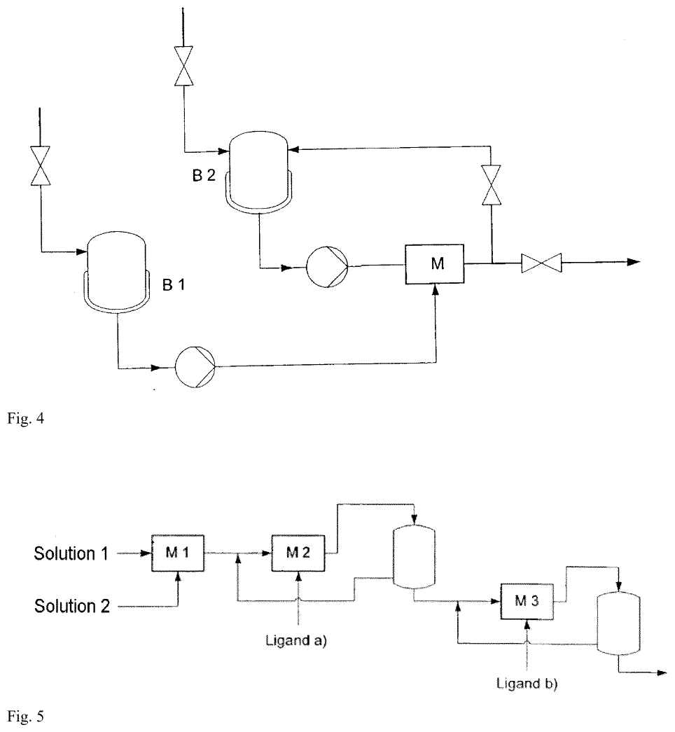

The DMC catalyst dispersion is preferably prepared using a mixing nozzle, particularly preferably a jet disperser. Examples of suitable apparatuses are shown in FIGS. 4 and 5. FIG. 4 shows a semi-batchwise process using a loop reactor and FIG. 5 shows a continuous process for preparing the DMC catalyst dispersion.

In one embodiment of the process according to the invention, the preparation of the double metal cyanide catalyst (DMC) comprises
i) in a first step, reaction of the aqueous solution of the cyanide-free metal salt, the aqueous solution of the metal cyanide salt, the organic complex ligand and the complex-forming component containing one or more compounds (1) of formula (I) (according to claim 1) to form a dispersion;
(ii) optionally, in a second step, separation of the solid from the dispersion obtained from (i);
(iii) optionally, in a third step, washing of the isolated solid with an aqueous solution of an organic complex ligand by means of a filtercake washing operation;
(iv) and optionally, in a fourth step, drying of the solid obtained.

### Step i)

The aqueous solutions of the cyanide-free metal salt, for example zinc chloride, used in stoichiometric excess (at least 50 mol % based on the metal cyanide salt), and of the metal cyanide salt, for example potassium hexacyanocobaltate, are preferably first reacted in the presence of the organic complex ligand, which may for example be tert-butanol, to form a dispersion. This DMC catalyst dispersion is preferably prepared using a mixing nozzle, particularly preferably a jet disperser.

The preparation of the DMC catalyst dispersion in the semi-batchwise process using a jet disperser in combination with a loop reactor (as per FIG. 4) will be elucidated hereinbelow. Here either the aqueous solution of a cyanide-free metal salt can be circulated from the vessel B2 and the aqueous metal cyanide solution can be metered in from vessel B1, or vice versa. When both streams are combined in the mixing element M, a dispersion of the DMC compound is formed. The dispersion of the DMC compound can be prepared by method 1, 2 or 3, preferably by method 2 or 3. The advantage of these methods resides in the possibility of realizing a constant reactant ratio during the entire precipitation process.

Preferably, the dispersion formed after the precipitation is circulated through the jet disperser for an additional few minutes to several hours.

The nozzle diameters are in this case preferably between 2000 μm to 200 μm with pressure drops in the nozzle of between 0.1 bar to 1000 bar.

The organic complex ligand can in this case be present in the aqueous solution of the cyanide-free metal salt and/or of the metal cyanide salt, or it is metered directly into the dispersion obtained after precipitation of the double metal cyanide compound (via vessel B1 or B2).

In one embodiment of the process according to the invention, the dispersion circulating through the jet disperser subsequently has a complex-forming component containing one or more compounds (1) of formula (I) metered into it via container B1 or B2. The complex-forming component containing one or more compounds (1) of formula (I) is preferably employed in a mixture of water and organic complex ligand.

The metered addition of the complex-forming component containing one or more compounds (1) of formula (I) into the circuit and a subsequent recirculation is preferably carried out with pressure drops in the nozzle of between 0.001 bar and 10 bar.

According to the invention, the DMC catalyst dispersion can also be prepared in a continuous process as is shown by way of example in FIG. 5. The aqueous solutions of the cyanide-free metal salt and of the metal cyanide salt are reacted according to method 1, 2 or 3 in the mixing element M1 to form a dispersion. The organic complex ligand may be present here in the aqueous solution of the cyanide-free metal salt and/or of the metal cyanide salt. In this case, the mixing stage M2 is dispensed with in FIG. 5. It is also possible to add the organic complex ligand after the precipitation of the double metal cyanide compound via the mixing element M2. To increase the residence time of the dispersion, the latter can be circulated via the mixing element M2. The complex-forming component containing one or more compounds (1) of formula (I)-preferably in a mixture of water and organic complex ligand-can subsequently be added in the mixing element M3 and recirculated to increase the residence time.

### Process Temperature

In a preferred embodiment of the process according to the invention, the process temperature in step i) is between 26° C. and 49° C., preferably between 28° C. and 47° C., particularly preferably between 29° C. and 42° C. and very particularly preferably between 30° C. and 40° C. The process temperature here corresponds to the process temperature in container B2 in FIG. 4. A process temperature between 26° C. and 49° C., preferably between 28° C. and 47° C., particularly preferably between 29° C. and 42° C. and very particularly preferably between 30° C. and 40° C. leads to a further improvement in the activity of the DMC catalyst.

### Step (ii)

In a preferred embodiment of the process according to the invention, in a second step (ii), the solid is separated off from the dispersion obtained from (i).

This involves isolating the solid (that is to say the precursor to the catalyst according to the invention) from the dispersion by known techniques, such as centrifugation or filtration.

Suitable filter apparatuses are described, for example, in “Ullmann's Encyclopedia of Industrial Chemistry”, Vol. B 2, chapters 9 and 10, VCH, Weinheim, 1988 and H. Gasper, D. Oechsle, E. Pongratz (eds.): “Handbuch der industriellen Fest/Flüssig-Filtration” [Handbook of industrial solid-liquid filtration], Wiley-VCH Verlag GmbH, Weinheim, 2000.

The pressure gradient required for the filtration can be applied here by gravitational force, by centrifugal force (e.g. filter centrifuges), preferably by gas differential pressure (e.g. vacuum filter or pressure filter) or by liquid pressure (e.g. filter presses, drum or disk filters and also possibly crossflow filtration modules).

For removal of the catalysts, both discontinuously and continuously operated filter apparatuses may be used. Examples of discontinuously operating filter apparatuses are peeler centrifuges and inverting filter centrifuges, membrane, chamber, frame or tube filter presses, automatic filter presses, autopress devices, pressure plate, cartridge and plate filters and also vacuum and pressure suction filters. Examples of continuously operating filter apparatuses are belt filter presses, pressure and vacuum drum filters, pressure and vacuum disk filters, belt filters and crossflow filters.

For the filtration of the DMC catalyst dispersion, on the laboratory scale vacuum or pressure filters or vacuum or pressure suction filters are particularly suitable; on the pilot plant and operational scale pressure suction filters, filter presses and automatic filter presses are particularly suitable.

On the pilot plant scale, membrane filter presses have proven to be particularly suitable. These, with the aid of a suitable filter cloth, preferably a membrane cloth, enable the filtration of the DMC catalyst dispersion on the basis of an applied liquid pressure gradient.

The filtration is generally conducted at temperatures of from 10 to 80° C. The pressure differences applied may be 0.001 bar to 200 bar, preferably 0.1 bar to 100 bar, particularly preferably 0.1 bar to 25 bar, the pressure difference applied depending on the apparatus used.

### Step (iii)

The isolated solid obtained in step (ii) can be washed by means of redispersion or filtercake washing.

In a preferred embodiment of the process according to the invention, in a third step (iii), the isolated solid is washed with an aqueous solution of an organic complex ligand by means of a filtercake washing operation.

The filtercake washing is performed here preferably by slurrying or preferably by flow-through washing. Here, the washing liquid flows through the cake and the liquid previously present in the cake is displaced, with diffusion effects also becoming effective. The removal of moisture from the washed cake can be effected by gas differential pressure, centrifugal force or mechanical pressing, or preferably in a combined manner by removal of moisture by gas differential pressure followed by mechanical pressing out. The pressure for the mechanical pressing out can be applied in this case both mechanically and by membranes.

With the aid of the filtercake washing, the preparation process is simplified and as a result also accelerated. The preferred ratio of washing liquid to filtercake volume lies at the amounts which bring about a complete exchange of the amount of liquid present in the original filtercake.

In an alternatively preferred embodiment variant of the process according to the invention, the isolated solid is subsequently washed in a third process step with an aqueous solution of the organic complex ligand (e.g. by redispersion and subsequent reisolation by filtration or centrifugation). This makes it possible to remove, for example, water-soluble by-products such as potassium chloride from the catalyst according to the invention. The amount of the organic complex ligand in the aqueous wash solution is preferably between 40% and 80% by weight, based on the overall solution.

The third step optionally comprises admixing the aqueous wash solution with a complex-forming component containing one or more compounds (1) of formula (I), preferably in the range between 0.5% and 5% by weight, based on the overall solution.

It is moreover advantageous to wash the isolated solid more than once. Preferably, in a first wash step (iii-1), is with an aqueous solution of the organic complex ligand (for example by redispersion and subsequent reisolation by filtration or centrifugation), in order in this way to remove, for example, water-soluble by-products such as potassium chloride from the catalyst according to the invention. It is particularly preferable when the amount of the organic complex ligand in the aqueous wash solution is between 40% and 80% by weight, based on the overall solution of the first wash step. In the further wash steps (iii-2), either the first wash step is repeated once or more than once, preferably once to three times, or preferably a nonaqueous solution, for example a mixture or solution of organic complex ligand and complex-forming component containing one or more compounds (1) of formula (I) (preferably in the range between 0.5% and 5% by weight, based on the total amount of the wash solution of step (iii-2)), is used as wash solution and the solid is washed with it once or more than once, preferably once to three times.

### Step (iv)

In a preferred embodiment of the process according to the invention, in a fourth step (iv), the solid obtained is subsequently dried.

The isolated and possibly washed solid here is subsequently dried at temperatures of in general 20-100° C. and at pressures of in general 0.1 mbar to standard pressure (1013 mbar), optionally after pulverizing.

### Steps (ii) and (iii)

In a preferred embodiment of the process according to the invention, steps (ii) and (iii) are performed in a filter press.

It has proven to be advantageous to press out the washed filtercake after the filtercake washing at pressures of from 0.5 to 200 bar, preferably at the highest possible pressures. This can be done, for example, directly following the filtercake washing in a filter press or by means of other suitable pressing apparatuses which enable a mechanical pressure to be applied so that the liquid present in the filtercake can escape through a membrane or a suitable filter cloth. The mechanical removal of moisture from the filtercake, which follows the washing of the filtercake and is preferably to be carried out prior to the drying, can preferably take place in the filter press, preferably by mechanical pressing out via a pressure exerted onto the membranes. The mechanical removal of moisture preferably leads to a maximum removal of the washing liquid from the filtercake.

### Steps (ii), (iii) and (iv)

The DMC catalyst is subsequently dried at temperatures of about 20 to 100° C. and at pressures of about 0.1 mbar to standard pressure (1013 mbar). Contact dryers and convection dryers and also spray dryers are suitable for this. The drying is preferably also performed directly in the apparatuses for the mechanical removal of liquid if these are suitable therefor (e.g. suction dryer, centrifugal dryer, “hot filter press”).

In a particularly preferred embodiment of the process according to the invention, steps (ii), (iii) and (iv) are performed in a heatable filter press.

The process preferably employs the heatable filter press. This is constructed as a conventional filter press with a membrane package. In terms of design, the membrane plates to be used differ from conventional membrane plates in that a heating medium can flow through the space behind the membrane. Liquid-tight (so-called “drip-” or “gas-tight”) membrane filter plates are preferably used.

The heated heating medium flows past the filtercakes on the rear side of the press membranes, completely separated from the filtercake by the press membrane and the filter medium, and in the process heats the filtercakes. The pressing medium is in this case under a sufficiently high pressure to ensure contact of the membranes with the filtercakes. The filtercakes can be heated on one or both sides. Heating on both sides is favorable with regard to the drying time.

A vacuum is applied on the filtrate side to assist with the drying process. This vacuum can for example be generated by a liquid-ring pump. The vapor stream suctioned off is cooled upstream of the vacuum pump in order to condense out the volatile constituents (e.g. tert-butanol and water). Measured and controlled variables are the amount condensed out, the pressure in the filtrate system of the press and the filtercake temperature.

In the process described, the membrane press pressures are preferably 0.1 bar to 10 bar. Temperatures of the pressing and heating medium are 30° C. to 80° C., preferably 40° C. to 60° C. The filtrate-side pressure is preferably less than 100 mbar. The flow rate of the heating medium should be chosen to be sufficiently high that there is a good heat transfer between the heating medium and the product. Drying times are in general a few minutes to a plurality of hours, typically one to ten hours. Residual moisture contents of below the target value of approx. 5% are reliably achieved with this type of drying.

In further process steps, the product thus isolated and freed from secondary components can be ground and packaged.

### Product-by-Process Claim

The present invention further provides the DMC catalyst prepared by the process according to the invention.

The present invention further provides for the use of the DMC catalysts prepared by the process according to the invention in a process for preparing polyoxyalkylene polyols, preferably polyether polyols by polyaddition of alkylene oxides onto starter compounds having active hydrogen atoms and/or polyethercarbonate polyols by polyaddition of alkylene oxides onto starter compounds having active hydrogen atoms in the presence of carbon dioxide.

The DMC catalysts prepared by the process according to the invention can, by virtue of their extraordinarily high activity, frequently be used in very low concentrations (25 ppm and less, based on the amount of the polyoxyalkylene polyol to be prepared, preferably the polyether polyol). If the polyoxyalkylene polyols, preferably polyether polyols, prepared in the presence of the DMC catalysts prepared by the process according to the invention are used for the preparation of polyurethanes, removal of the catalyst from the polyoxyalkylene polyol, preferably polyether polyol, can be dispensed with without disadvantageously affecting the product qualities of the polyurethane obtained.

### EXAMPLES

OH numbers were determined according to the procedure of DIN 53240. Viscosities were determined by rotary viscometer (Physica MCR 51, manufacturer: Anton Paar) in accordance with the procedure of DIN 53018.

### Preparation of the DMC Catalysts

### Example 1 (Comparative)

The catalyst was prepared using an apparatus as per FIG. 4 from WO 01/39883 A1.

In a loop reactor containing a jet disperser as per FIG. 2 from WO 01/39883 A1 having one bore (diameter 0.7 mm) was circulated a solution of 258 g of zinc chloride in 937 g of distilled water and 135 g of tert-butanol at 35° C. (determined in the vessel D2 in FIG. 4 of WO 01/39883 A1). To this was metered a solution of 26 g of potassium hexacyanocobaltate in 332 g of distilled water. The pressure drop in the jet disperser was 2.9 bar. Subsequently, the dispersion formed was circulated for 60 min at 35° C. with a pressure drop in the jet disperser of 2.9 bar. Thereafter, a mixture of 5.7 g of tert-butanol, 159 g of distilled water and 27.6 g of polypropylene glycol 1000 (PPG-1000) was metered in and the dispersion was then circulated for 80 min at 35° C. with a pressure drop in the jet disperser of 2.9 bar.

230 g of the dispersion obtained were filtered in a pressure suction filter with filter area 20 cm², and then washed with a mixture of 82 g of tert-butanol, 42.3 g of distilled water and 1.7 g of polypropylene glycol 1000. The washed filtercake was squeezed mechanically between two strips of filter paper and finally dried at 60° C. under high vacuum at about 0.05 bar (absolute) for 2 h.

### Example 2

Example 2 was performed analogously to example 1 (comparative) with the exception that in the relevant preparation steps tri-sec-butylphenol ethoxylate with 13 EO (Clariant® Sapogenat T 130) was used instead of polypropylene glycol 1000 (PPG-1000) in identical amounts of 27.6 g and 1.7 g respectively.

### Example 3

Example 3 was performed analogously to example 1 (comparative) with the exception that in the relevant preparation steps tri-sec-butylphenol ethoxylate with 18 EO (Clariant® Sapogenat T 180) was used instead of polypropylene glycol 1000 (PPG-1000) in identical amounts of 27.6 g and 1.7 g respectively.

### Example 4

Example 4 was performed analogously to example 1 (comparative) with the exception that in the relevant preparation steps tri-sec-butylphenol ethoxylate with 50 EO (Clariant® Sapogenat T 500) was used instead of polypropylene glycol 1000 (PPG-1000) in identical amounts of 27.6 g and 1.7 g respectively.

### Catalyst Test (“8K Diol Stressed Test”)

The DMC catalysts were tested in the so-called “8K diol stressed test”. Here, a polypropylene glycol having a calculated OH number=14 mg KOH/g, that is to say molecular weight=8000 g/mol (“8K diol”) was prepared proceeding from a bifunctional polypropylene glycol starter having an OH number=147 mg KOH/g (“Arcol Polyol 725” from Covestro) with a short propylene oxide metering time (30 minutes). The decisive evaluation criterion for the catalyst quality/activity in this test is the viscosity of the polyol obtained, with a DMC catalyst of increased quality/activity leading to a lower 8K diol viscosity.

### General Implementation

A 1 liter stainless steel reactor was initially charged with 75 g of a bifunctional polypropylene glycol starter (OH number=147 mg KOH/g) and 30.7 mg of DMC catalyst. After 5 cycles of nitrogen/vacuum exchange between 0.1 and 3.0 bar (absolute), the reactor contents were heated to 130° C. with stirring (800 rpm). The mixture was then stripped with nitrogen for 30 min at 130° C. and 100 mbar (absolute). 7.5 g of propylene oxide were then added at 130° C. and 100 mbar (absolute) to activate the catalyst. The catalyst activation manifested in an accelerated pressure drop in the reactor. After the catalyst had been activated, the remaining propylene oxide (685.7 g) was metered in within 30 min at 130° C. with stirring (800 rpm). After a post-reaction time of 30 min at 130° C., volatile constituents were distilled off under reduced pressure (<10 mbar) at 90° C. for 30 min. The product was then cooled down to room temperature and removed from the reactor.

The OH number and viscosity (25° C.) of the product obtained were measured. In the event of a deviation of the measured OH number from the calculated OH number (14 mg KOH/g), a “corrected viscosity” was determined from the measured viscosity using the following formula:

Corrected viscosity (25° C.)=measured viscosity (25° C.)+659*(OH number−14)

The results of the catalyst tests in the “8K diol stressed test” are summarized in table 1.

TABLE 1

| | | OH | Viscosity | Viscosity |
|---|---|---|---|---|
| | DMC | number | 25° C./ | 25° C./ |
| Catalyst test/ | catalyst/ | [mg | measured | corrected |
| Example | Example | KOH/g] | [mPas] | [mPas] |
| 5 (comp.) | 1 (comp.) | 14.0 | 4324 | 4324 |
| 6 | 2 | 14.1 | 3950 | 4016 |
| 7 | 3 | 14.2 | 3695 | 3827 |
| 8 | 4 | 13.9 | 3845 | 3779 |

The results show that, in the “8K diol stressed test” as a semi-batch polyol preparation process, DMC catalysts prepared using tri-sec-butylphenol ethoxylate as the complex-forming component result in lower viscosity values of the polyols compared to DMC catalysts using polypropylene glycol 1000 as the complex-forming component.

### Catalyst Test (Continuous Process):

A continuously operated stainless steel pressure reactor having an available reactor volume V_{R}. of 1.951 liters filled with a polyether polyol (OH functionality=2.82; OH number=48 mg KOH/g; propylene oxide/ethylene oxide ratio=89.5/10.5; containing 25 ppm DMC catalyst) had the following components metered into it at the reported mass flows at a temperature of 130° C. with stirring (800 rpm):
propylene oxide at 817.50 g/h
ethylene oxide at 95.51 g/h
glycerol at 21.69 g/h
dispersion of 0.00613 g of DMC catalyst in 1 g of propylene glycol at 3.83 g/h

The reaction mixture was continuously withdrawn from the pressure reactor while the reactor was always completely filled with liquid, and the reaction volume V therefore corresponded to the reactor volume V_{R}. Completion of the reaction was effected by continuously transferring the withdrawn reaction mixture into a postreactor (tubular reactor having an internal volume of 1.0 L) temperature controlled to 100° C. After exiting the postreactor the obtained product was cooled to room temperature and then subjected to analytical examination. Table 2 reports the analytical values for a sample taken after a total reaction time corresponding to 12 residence times.

OH number and viscosity (25° C.) were measured. In the event of a deviation of the measured OH number from the calculated OH number (48 mg KOH/g), a “corrected viscosity” was determined from the measured viscosity using the following formula:

$$corrected viscosity ( 25 ° C . ) = measured viscosity ( 25 ° C . ) + 13 * ( OHN - 48 )$$

TABLE 2

| | | OH | Viscosity | Viscosity |
|---|---|---|---|---|
| | DMC | number | 25° C./ | 25° C./ |
| Catalyst test/ | catalyst/ | [mg | measured | corrected |
| Example | Example | KOH/g] | [mPas] | [mPas] |
| 9 (comp.) | 1 (comp.) | 47.4 | 731 | 723 |
| 10 | 3 | 47.6 | 708 | 703 |
| 11 | 4 | 47.6 | 703 | 698 |

The results show that, in a continuous polyol preparation process too, DMC catalysts prepared using tri-sec-butylphenol ethoxylate as the complex-forming component result in lower viscosity values of the polyols compared to DMC catalysts using polypropylene glycol 1000 as the complex-forming component.

1. A process for preparing a double metal cyanide catalyst (DMC) comprising:
i) reacting an aqueous solution of a cyanide-free metal salt, an aqueous solution of a metal cyanide salt, an organic complex ligand and a complex-forming component, wherein the complex-forming component contains one or more compounds (1) of formula (I): 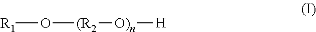
where
R₁ is a substituted or unsubstituted aryl group,
R₂ is an alkylene group, and
n has a value of ≥1.

2. The process as claimed in claim 1, wherein R₁ has a structure according to formula (II): 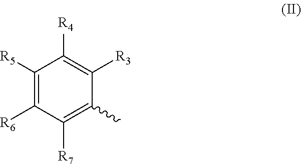
where R₃, R₄, R₅, R₆, R₇ are independently of one another selected from the group consisting of hydrogen, linear or branched alkyl groups having 1 to 22 carbon atoms, cycloaliphatic groups containing 3 to 22 carbon atoms and substituted or unsubstituted aryl groups having 6 to 16 carbon atoms.

3. The process as claimed in claim 1, wherein:
R₃, R₅, R₇ are independently of one another selected from the group consisting of linear or branched alkyl groups having 1 to 10 carbon atoms and substituted or unsubstituted aryl groups having 6 to 12 carbon atoms
and
R₄ and R₆ are hydrogen.

4. The process as claimed in claim 1, wherein R₁ has a structure according to formula (III), (IV) or (V):

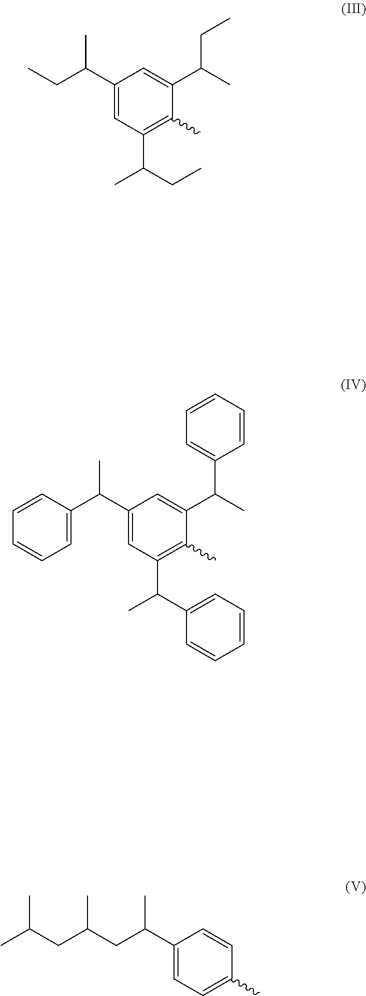

5. The process as claimed in claim 1, wherein the compound (1) has a structure according to formula (VI), (VII) and/or (VIII): 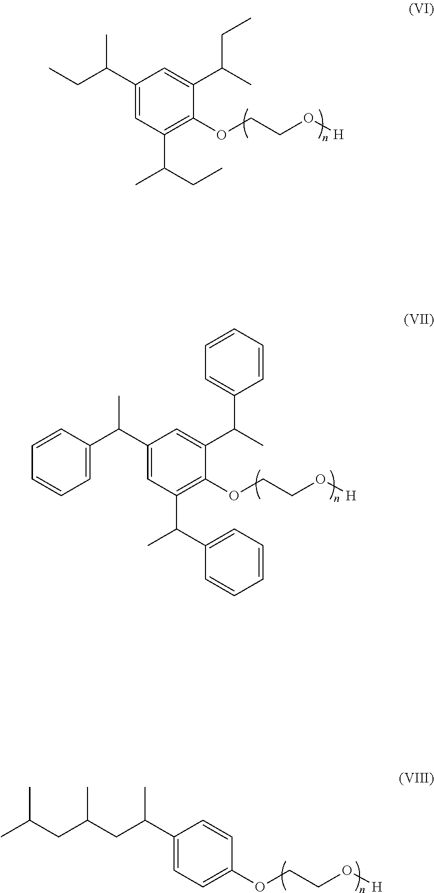
where n has a value of ≥1.

6. The process as claimed in claim 1, wherein double metal cyanide compounds of formula (XIV) are present in the DMC-catalyst 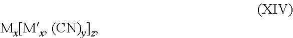
and M is selected from one or more metal cations of the group consisting of Zn(II), Fe(II), Ni(II), Mn(II), Co(II), Sr(II), Sn(II), Pb(II) and Cu(II),
and
M′ is selected from one or more metal cations from the group consisting of Fe(II), Fe(III), Co(II), Co(III), Cr(II), Cr(III), Mn(II), Mn(III), Ir(III), Ni(II), Rh(III), Ru(II), V(IV) and V(V),
and
x, x′, y and z are integers and are selected so as to ensure the electronic neutrality of the double metal cyanide compound.

7. The process as claimed in claim 1, wherein the double metal cyanide compound is one or more compounds selected from the group consisting of zinc hexacyanocobaltate(III), zinc hexacyanoiridate(III), zinc hexacyanoferrate(III) and cobalt(II) hexacyanocobaltate(III).

8. The process as claimed in claim 1, wherein the metal cyanide salt is one or more compounds selected from the group consisting of potassium hexacyanocobaltate(III), potassium hexacyanoferrate(II), potassium hexacyanoferrate(III), calcium hexacyanocobaltate(III) and lithium hexacyanocobaltate(III).

9. The process as claimed in claim 1, wherein the organic complex ligand is one or more compounds selected from the group consisting of dimethoxyethane, tert-butanol, 2-methyl-3-buten-2-ol, 2-methyl-3-butyn-2-ol, ethylene glycol mono-tert-butyl ether and 3-methyl-3-oxetanemethanol.

10. The process as claimed in claim 1, wherein the complex-forming component further contains a compound (2), wherein the compound (2) is a polyether.

11. The process as claimed in claim 10, wherein the molar ratio of compound (1) to compound (2) is from 50:1 to 1:50.

12. The process as claimed in claim 1, wherein the reaction in step i) is carried out using a mixing nozzle.

13. The process as claimed in claim 1, wherein the employed process temperature of the dispersion during the reaction in step i) is between 26° C. and 49° C.

14. A double metal cyanide catalyst (DMC) obtained by the process of claim 1.

15. A polyoxyalkylene polyol prepared using the double metal cyanide catalyst (DMC) as claimed in claim 14.

16. The process of claim 1, wherein R₃, R₅, R₇ are independently of one another selected from the group consisting of hydrogen, linear or branched alkyl groups having 1 to 22 carbon atoms, cycloaliphatic groups containing 3 to 22 carbon atoms and substituted or unsubstituted aryl groups having 6 to 16 carbon atoms, and R₄ and R₆ are hydrogen.

17. The process of claim 5, where n has a value of 5≤n≤80.

18. The process of claim 6, wherein M is selected from one or more metal cations of the group consisting of Zn(II), Fe(II), Co(II) and Ni(II), M′ is selected from one or more metal cations from the group consisting of Co(III), Fe(III), Cr(III) and Ir(III), x=3, x′=1, y=6 and z=2.

19. The process as claimed in claim 9, wherein the organic complex ligand is tert-butanol.

20. The process as claimed in claim 11, wherein the molar ratio of compound (1) to compound (2) is from, preferably 20:1 to 1:20.
